(19) United States
(12) Patent Application Publication
(10) Pub. No.: US 2006/0283917 A1
(43) Pub. Date: Dec. 21, 2006

(54) Method of soldering or brazing articles having surfaces that are difficult to bond

(75) Inventor: Sungho Jin, San Diego, CA (US)

Correspondence Address: DOCKET ADMINISTRATOR;LOWENSTEIN SANDLER PC, 65 LIVINGSTON AVENUE, ROSELAND, NJ, 07068, US

(73) Assignee: The Regents of the University of California, Oakland, CA (US)

(21) Appl. No.: 10/552,210

(22) PCT Filed: Apr. 7, 2004
(86) PCT No.: PCT/US04/10632

§ 371 Date: Aug. 10, 2006

Related U.S. Application Data
(60) Provisional application No. 60/461,476, filed on Apr. 9, 2003.

(51) Int. Cl. B23K 20/12

(52) U.S. Cl. 228/112.1

(57) ABSTRACT

Applicant has discovered that articles comprising inorganic surfaces that are difficult to bond can be more effectively soldered or brazed with a solder or braze containing rare earth elements where the rare earth (RE) elements are substantially kept from contact with air at soldering temperatures, i.e. the RE elements are exposed to air for no more than a few seconds at soldering temperature. This can be efficiently accomplished in several ways. The result is efficient, strong bonding of materials previously considered difficult to bond.

### FIELD OF THE INVENTION

This invention relates to methods of soldering or brazing and, in particular, to a method of soldering or brazing surfaces that are difficult to bond, such as surfaces comprising inorganic materials. It also includes novel articles made by the method.

### BACKGROUND OF THE INVENTION

Bonding using solder or braze is highly important in the fabrication of a variety of important optical, electronic and micro-electro-mechanical (MEMs) devices. Solders comprise low melting compositions composed of elemental metal or metal alloy. They typically melt at temperatures lower than about 450° and are very useful in bonding together surfaces to which the solder adheres. Brazes are similar materials of higher melting temperature and are used to form more thermally resistant bonds. Solder and brazes are used, for example, assembling lasers, bonding optical fibers to assembly substrates, connecting electronic components to assembly boards, and to assembling MEMs chips.

While solders and brazes are generally very effective in bonding to many surfaces, they have been considerably less effective in bonding to stable inorganic surfaces such as oxides, nitrides, selenides, silicon, GaAs, GaN, other semiconductors, fluorides, diamond, and stable metals. These materials, which are increasingly used in high performance optical, electronic and MEMs devices, form relatively stable surfaces that have little tendency to chemically react with molten solder material. The result is low adherence and a weak bond.

Solder bonding and brazing of these stable, inorganic materials can be enhanced by pre-treating the surfaces with multilayer metallization to present a more bondable surface, e.g. the well-known Ti/Pt/Au sputter-deposited metallization. But multiple coatings complicate production, add costs and introduce additional reliability concerns.

Another approach is to make the solder or braze more reactive, as by adding reactive rare earth elements (RE elements). The resulting more reactive solders are known as universal solders. The difficulty is that universal solders which react with stable inorganic materials also react with less stable ambient materials, with deleterious consequences to the solder braze or bond. Accordingly there is a need for improved methods of soldering or brazing articles having surfaces that are difficult to bond.

### SUMMARY OF THE INVENTION

Applicant has discovered that articles comprising inorganic surfaces that are difficult to bond can be more effectively soldered or brazed with a solder or braze containing rare earth elements where the rare earth (RE) elements are substantially kept from contact with air at soldering temperatures, i.e. the RE elements are exposed to air for no more than a few seconds at soldering temperature. This can be efficiently accomplished in several ways. The result is efficient, strong bonding of materials previously considered difficult to bond.

### BRIEF DESCRIPTION OF THE DRAWINGS

The nature, advantages and various additional features of the invention will appear more fully upon consideration of the illustrative embodiments now to be described in detail in connection with the accompanying drawings. In the drawings:

FIG. 1 is a schematic flow diagram of a method of brazing or soldering articles in accordance with the invention;

FIGS. 2A through 2D illustrate various configurations of universal solder bodies that can be used in the process of FIG. 1;

FIG. 3 shows vacuum bonding;

FIGS. 4A and 4B illustrate rapid application and bonding;

FIGS. 5A and 5B show bonding by mechanical collapse of a preform body;

FIGS. 6A and 6B show bonding by local heating collapse of a preformed body;

FIG. 7 illustrates a MEMs multilayer structure bonded in accordance with the invention;

FIG. 8 shows an assembly for a MEMs device hermetically packaged in accordance with the invention;

FIG. 9 illustrates an optical fiber/laser assembly bonded in accordance with the invention; and

FIGS. 10 and 11 illustrate fiber grating devices bonded in accordance with the invention.

It is to be understood that the drawings are for purposes of illustrating the concepts of the invention and are not to scale.

### DETAILED DESCRIPTION OF THE INVENTION

Applicant has observed that the very reactive rare earth elements used in universal solders easily oxidize and solders or brazes containing them form oxide skins with high melting points (e.g., −2300° C.) when heated or melted. Rapid oxidation of rare earth elements on the surface of molten universal solders tends to deteriorate the solder wetting characteristics. Universal solder bonding processes conducted in oxygen-containing atmospheres, such as the air, offer only a short window for wetting and joining before oxidation. Once oxidation begins, an undesirable rare-earth-rich, gray oxide skin is formed on the surface of the universal solder that prevents the universal solder from wetting surfaces to be bonded. The oxide skin also impairs the diffusion of rare earth atoms from the interior of the solder to the interface to be bonded and prevents the universal solder from forming a strong solder bond.

In an effort to ameliorate this problem applicant has previously proposed various approaches to modify the composition and/or structure of universal solders to isolate and effectively bury the RE components underneath the solder surface. The approaches include jacketing the universal solder with regular solder, coating the universal solder with noble metal or ion implanting of RE elements beneath the surface of regular solder. See published United States Patent Application No. 2002/0106528 filed by S. Jin et al. While the approach of burying the RE components has improved the bonding of universal solders, additional improvement is desired for use in bonding stable inorganic surfaces. Specifically, applicant has discovered that soldering or brazing such surfaces are substantially improved by wetting and bonding with universal solder under substantially oxygen-free conditions.

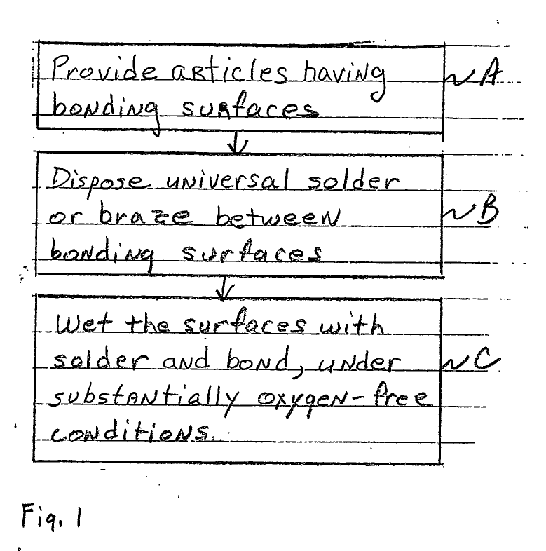

FIG. 1 is a schematic flow chart of a method of brazing or bonding two or more articles in accordance with the invention. The first step shown in Block A, is to provide two or more articles having respective surfaces to be bonded. The invention is particularly valuable when one or more of the bonding surfaces is a stable inorganic surface such as oxide, nitride, selenide, silicon, GaAs, GaN or other semiconductor, fluoride diamond or stable metal.

The next step, shown in Block B, is to dispose between the bonding surfaces a universal solder or braze, advantageously in the form of a body comprising the solder or braze. By the term “universal solder” is meant a low melting temperature solder doped with at least one rare earth element. Advantageously the low melting temperature solder comprises 0.1 to 10% by weight of one or more rare earth elements. Suitable low-melting temperature solders for use in the universal solder include, but are not limited to, Sn—Sb, Bi—Sn, In—Sn, In—Ag, Pb—Sn, Sn—Ag, and eutectic Au—Sn. Suitable rare earth dopants include, but are not limited to, Lu, Er, Ce, Y, Sn, Gd, Th, Dy, Tm and Yb. Brazes are similar compositions with propositions chosen for higher melting temperatures.

The universal solder can be in the form of a simple alloyed universal solder of the components described above, such as: Sn—Ag-RE, Au—Ag-RE, Sn—Sb-RE, Bi—Sn-RE, In—Sn-RE, In—Ag-RE, Sn—Ag-RE. However the preferred form is a body configured, as set forth in U.S. published patent Application No. 2002/0106528, to bury the RE elements within the interior of the solder body.

FIGS. 2A-2D illustrate various configurations of universal solder bodies that can be used. FIG. 2A shows a universal solder body 20. FIG. 2B illustrates a protective coating on film 21 of noble metal covering a universal solder core 22. FIG. 2C shows a universal solder core 22 with regular solder jacket 23, and FIG. 2D illustrates a universal solder paste comprised of solder particles 25 in a paste 26 matrix. The particles 25 can comprise universal solder particles coated with noble metal.

Referring back to FIG. 1, the third step in the process is to wet and bond the surfaces under substantially oxygen-free conditions. This can be efficiently accomplished in at least four different ways:

1) vacuum bonding;

2) rapid application of molten universal solder;

3) controlled collapse joining with universal solder, and

4) rapid and localized heating by deposition of a resistive heating element. Each of these approaches are exemplified below.

### EXAMPLE 1

### Vacuum Bonding

One method of minimizing the universal solder's exposure to an oxygen-containing atmosphere is by conducting the bonding in a vacuum. Solder bonding in a vacuum offers a viable batch-type packaging process, especially suited for hermetically sealing MEMS devices, optical devices and/or electronic devices.

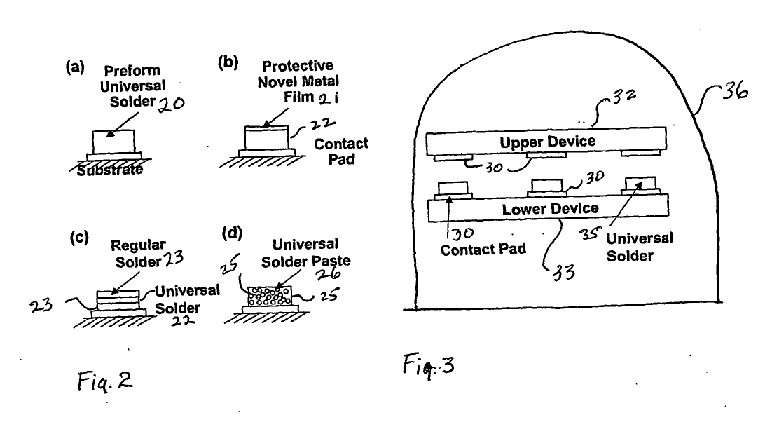

FIG. 3 schematically illustrates the step of wetting and bonding the surfaces 30 of an assembly 31 of two articles 32, 33 (e.g. MEMs upper (32) and lower (33) parts) in a substantially oxygen-free ambience. Here the articles 32, 33 have bonding surfaces (contact pads) 34 and bodies 35 comprising universal solder are disposed between contact pads of the respective parts. The assembly 31, in turn, is disposed within a vacuum chamber 36 including a heater (not shown) and in communication with a vacuum pump. The chamber is advantageously evacuated to a pressure of 10⁻⁶ torr or less, preferably 10⁻⁷ torr or less, and even more preferably to 5×10⁻⁸ torr or less. The assembly is heated and pressed together under vacuum to effect wetting and bonding without the presence of ambient atmospheric oxygen.

The vacuum bonding process using a universal solder described herein is suited for use in fabricating MEMS devices, which are micromachines of small dimensions. For example, many MEMS devices to be bonded with a universal solder may be arranged, using automated assembly processing, on each of a multitude of shelves and placed in a vacuum chamber equipped with a capability to render either global or local heating. Each packaging assembly would have a lower device or substrate, preforms of a universal solder placed on contact pads or hermetic seal pads, and the upper device placed over the universal solder preforms with appropriate alignment and convenient fixturing array to maintain the alignment The preform can be either bulk solder or thin film deposited solder.

### EXAMPLE 2

### Rapid Application of Molten Universal Solder

For universal solder bonding to produce successful solder bonding in oxygen-containing atmosphere such as the air, there is a time window of a minute or less and preferably less than 10 seconds to accomplish the wetting and joining before the oxidation of the universal solder takes place and an undesirable rare-earth-rich, gray colored oxide skin is formed that impedes further wetting. One way of carrying out desirably rapid solder bonding is by introducing controlled and rapid application of molten solder, preferably by using rapid automated processes. Carrying out such an inventive process is preferably done in an inert gas atmosphere, although this is not an absolute requirement.

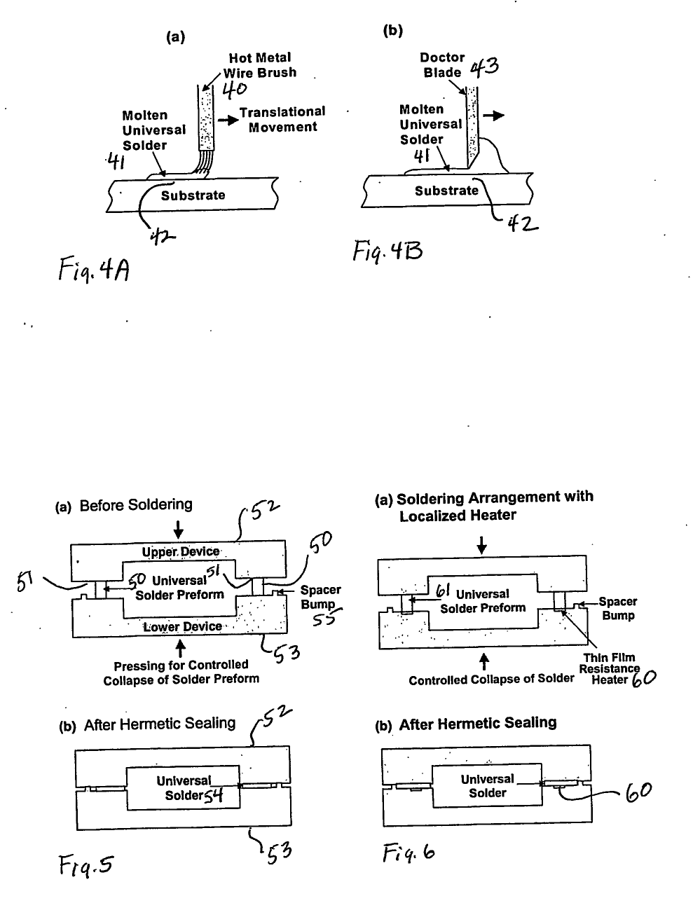

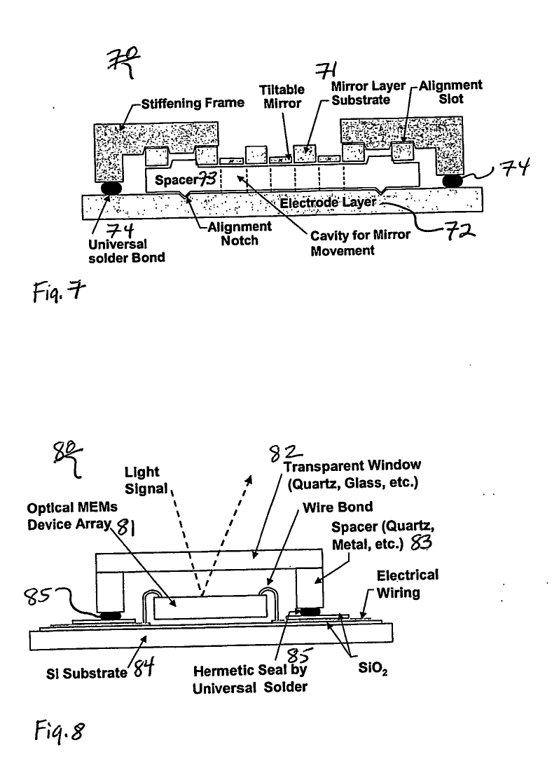

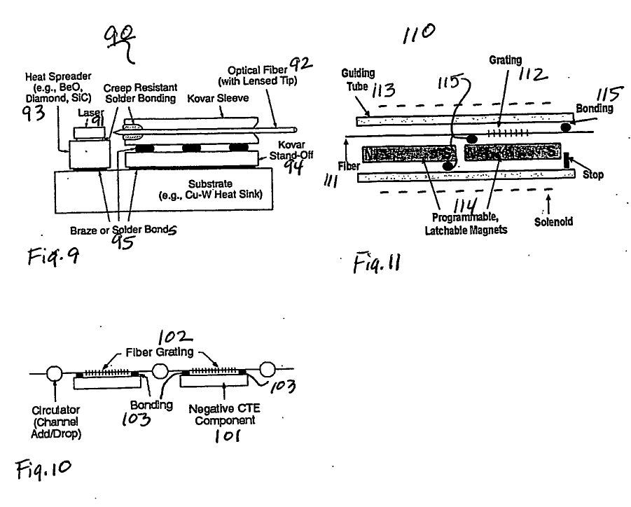

FIG. 4A illustrates such a rapid application step using a hot metal brush 40 to pick up a volume of molten universal solder 41 from a molten bath (not shown) and, quickly coat a bonding surface 42 such as a hermetic seal pads (pre-heated if necessary). An upper device (not shown) is then quickly placed and pressed on top of the molten solder 41 to form a joint. Natural air cooling or an air blast may be used to initiate the solidification of the solder joint. The time from the brushing to the formation of the solder joint should be a minute or less and preferably is 10 seconds or less.

FIG. 4B shows an alternate rapid application step using a metallic doctor blade trailing a wire solder depositing brush (not shown) to produce a uniform thickness solder layer 41. The upper device is placed and pressed on the bladed solder.

### EXAMPLE 3

### Controlled Collapse Joining with Universal Solder

If the undesirable oxide skin formed on the surface of molten universal solder can be broken off, fresh universal solder can be released into immediate contact with the bonding surface. In such case, the contact areas are sealed against ambient oxygen by surrounding molten solder and desired universal solder bonding can be achieved in air.

FIGS. 5A and 5B illustrate the step of wetting and bonding using a mechanical disturbance to break the skin off molten solder so that the solder/surface contact is self-sealed from ambient oxygen. Specifically, relatively tall universal solder preform bodies 50 placed between the surfaces 51 to be bonded are melted and then the upper device 52 and lower device 53 are pressed together to collapse the molten solder 54. The collapse breaks the oxide skin and allows fresh solder to wet and bond the device surface. Small spacer bumps 55 can be dimensional and placed to pre-set the solder joint thickness.

### EXAMPLE 4

### Rapid and Localized Heating by Deposition of a Heating Element

Another way to minimize oxidation of the molten solder surface is to melt the solder rapidly and thus minimize the time of oxidation.

FIGS. 6A and 6B schematically illustrate an exemplary rapid heating step. Here resistive heating elements 60 such as resistive films of Mo or W are disposed in thermal contact with universal solder bodies 61. An electrical current passed through elements 60 rapidly melts the bodies 61. The heating elements, if deposited on the pads can remain as a buried part of the solder joint because the universal solder bonds well to the resistive materials.

We now describe several exemplary advantageous applications of the method of FIG. 1 to make articles.

### Articles Fabricated Using the Bonding Methods of the Invention

The universal solder materials and bonding techniques described here can useful for a variety of applications for assembling various MEMS, optical devices and electronic devices, especially for creating reliable hermetic sealing and for permitting flip-chip assembly without introducing complicated metallizations of various surfaces to be bonded.

FIG. 7 illustrates a MEMS multilayer structure 70 bonded in accordance with the invention comprising light-reflecting mirror layer 71, an electrode layer 72, a spacer layer 73, and a stiffening frame 75 to hold the components together. See R. Ryf, et al, “1296-Port MEMS Transparent Optical Crossconnect with 2.07 Petabits/s Switch Capacity”, OFC'2001 (Optical Fiber Conference), Paper No. PD-28, Mar. 17-22, 2001, Anaheim Calif., USA. Universal solder bonds 74, made in accordance with the method of FIG. 1, can be used to hold the components together within the stiffening frame 75.

FIG. 8 shows an assembly 80 for an optical MEMs device 81 hermetically packaged in accordance with the invention. The device 81 is sealed on substrate 84 by a transparent window 82 on a spacer 83. Universal solder bonds 85, made in accordance with the method of FIG. 1, can hermetically seal the spacer/window enclosure to the substrate 84.

Yet another example is the bonding of optical fiber devices. The universal solders are directly solderable to optical fibers, and hence are technically useful for a variety of applications in optical communication devices.

FIG. 9 illustrates an assembly 90 optically coupling a semiconductor laser 91 in alignment with an optical fiber 92. The laser 91 is mounted on a heat spreader 93, and the fiber 92 is mounted on a standoff 94 in precise optical alignment with the laser output. Creep resistant bonding is essential for securing and maintaining alignment between the laser and the fiber. Tight micrometer tolerance in dimensional stability is required. The critical bonds 95 can be made using the method of FIG. 1 and creep resistant solders such as those based on Sn—Ag-RE or Au—Sn-RE eutectic solder.

Fiber gratings are SiO₂ based optical fiber devices with internal periodic refractive index perturbations along the fiber length corresponding to specific Bragg reflections for a certain wavelength of optical signals. They are frequently used for filtering specific, designated wavelength channels in wavelength-division-multiplexed optical communication systems. They need to be temperature-compensated to eliminate the fluctuation of refractive index of the grating with ambient temperature. One way of accomplishing this is to attach a negative CTE (coeffecient of thermal expansion) material. See, H. Mavoori and S. Jin, “Low Thermal Expansion Copper Composites via Negative CTE Metallic Elements”, JOM 50(6), 70 (June, 1998); A. W. Sleight, A. W. Nature 389 (6654), 923 (1997).

FIG. 10 illustrates a temperature compensated fiber grating device 100 assembled by bonding of a negative thermal expansion material 101 such as Ni—Ti or Zr-Tungstate on an elastically pre-strained fiber grating 102 such that when the ambient temperature rises, the strain in the grating 102 is reduced by the attached negative CTE material 101. The fiber and the negative CTE material 101 are attached by universal solder bonds 103 made in accordance with the method of FIG. 1.

The rare-earth containing solders can also be useful for convenient assembly of wavelength-tunable fiber gratings, such as those described in an article by S. Jin, et al., “Broad-range, latchable reconfiguration of Bragg wavelength in optical gratings”, Appl. Phys. Lett. 74 (16), 2259 (1999). Other examples include hermetic sealing of RF relay MEMS switches [see an article by J. Kim, et al., “Integration and Packaging of MEMS Relays”, SPIE Conf. Proc. on MEMS, May 2000, Paris, France] which can be useful for management of electronic data in automated test systems or control of communication information flow. The speed of movement of MEMS membranes, and hence the switching speed, is significantly reduced by air damping. For higher speed operations of such MEMS switches, hermetic sealing with vacuum environment is desirable. Hermetic sealing of such MEMS devices may involve simultaneous bonding to various surfaces such as Si, insulators like SiO₂, SiNₓ, and electrical wiring made of poly Si or Al lines. Universal solders have desirable characteristics of being able to bond to all these different surfaces simultaneously during hermetic sealing.

FIG. 11 illustrates such a latchable, tunable fiber grating 110 comprising an optical fiber 111 having a grating 112 attached to a guiding tube 113 and a programmable latchable magnet 114. Key bonds 115 involving difficult to bond surfaces can be made using universal solders using the method of FIG. 1.

Although the present invention has been described in considerable detail with reference to certain preferred embodiments and versions, other versions and embodiments are possible. For example, while the examples are discussed in relation to bonding using solder, they could equally well be applied to brazes. Therefore, the spirit and scope of the appended claims should not be limited to the description of the versions and embodiments expressly disclosed herein.

1. A bonding method using a universal solder comprising:
disposing a first device comprising a contact pad within a vacuum chamber having a vacuum pressure;
placing a universal solder preform on the contact pad;
arranging a second device comprising a surface to be bonded within the vacuum chamber such that the surface to be bonded is aligned with the universal solder preform; and
pressing the second device onto the solder preform thereby forming a solder joint between the surface to be bonded and the first device.

2. The method of claim 1, wherein the vacuum pressure is 10⁻⁶ tort or less.

3. The method of claim 1, wherein the vacuum pressure is 10⁻⁷ torr or less.

4. The method of claim 1, wherein the vacuum pressure is 5×10⁻⁸ torr or less.

5. The method of claim 1 further comprising depositing a resistive heating element on a surface of at least one of the first or second devices for heating the universal solder preform.

6. The method of claim 1, wherein the solder joint is a hermetic seal.

7. The method of claim 1, wherein the universal solder preform is a bulk solder or thin film deposited solder.

8. The method of claim 1, wherein the first device is a substrate.

9. The method of claim 1, wherein at least one of the first and second devices comprises an electronic circuit device.

10. The method of claim 1, wherein at least one of the first and second devices comprises a microelectromechanical system device.

11. The method of claim 1, wherein at least one of the first and second devices comprises an optical device.

12. The method of claim 1, wherein the surface to be bonded comprises a material selected from the group consisting of oxides, nitrides, fluorides, sulfides, carbides, semiconductors, selenides, silicon, GaAs, GaN and diamonds.

13. A bonding method using a universal solder comprising:
coating at least a portion of a heated metal brush with a molten universal solder;
passing the brush with the molten universal solder over a first device thereby coating at least a portion of the first device with a layer of the molten universal solder; and
pressing a second device onto the layer of molten universal solder thereby forming a solder joint between the first device and the second device, wherein a time from the coating of the at least a portion of the first device to the formation of the solder joint is less than or equal to one minute.

14. The method of claim 13, wherein the time from the coating of the at least a portion of the first device to the formation of the solder joint is less than or equal to ten seconds.

15. The method of claim 13, wherein the formation of the solder joint takes place prior to surface oxidation of the molten universal solder.

16. The method of claim 13, wherein the bonding method is conducted in an inert gas atmosphere.

17. The method of claim 13 further comprising cooling of the solder joint to initiate solidification.

18. The method of claim 13 further comprising using a metallic knife to trail the heated metal brush and level off the molten universal solder layer to produce a uniform layer thickness.

19. The method of claim 13, wherein the fast device is a substrate.

20. The method of claim 13, wherein at least one of the first and second devices comprises an electronic circuit device.

21. The method of claim 13, wherein at least one of the first and second devices comprises a microelectromechanical system device.

22. The method of claim 13, wherein at least one of the first and second devices comprises an optical device.

23. The method of claim 13, wherein the second device comprises a material selected from the group consisting of oxides, nitrides, fluorides, sulfides, carbides, semiconductors, selenides, silicon, GaAs, GaN and diamonds.

24. The method of claim 13, wherein the first device comprises a hermetic seal pad.

25. The method of claim 24, wherein the hermetic seal pad is pre-heated.

26. A bonding method using a universal solder comprising:
providing a first device spaced apart from a second device, wherein a space between the first device and the second device forms a joint area;
placing a universal solder preform in the joint area;
melting the universal solder preform, wherein an oxide skin is formed on a surface of the molten universal solder preform; and
pressing the second device toward the first device to collapse the molten universal solder and create a mechanical disturbance of the oxide skin, thereby allowing fresh molten universal solder to form a solder joint between the first and second devices.

27. The method of claim 26 further comprising introducing a spacer bump in the joint area to pre-set a thickness of the collapsed universal solder in the joint area.

28. The method of claim 26 further comprising depositing a resistive heating element on a surface of at least one of the first or second devices for heating the universal solder preform.

29. The method of claim 26, wherein at least one of the first and second devices comprises an electronic circuit device.

30. The method of claim 26, wherein at least one of the first and second devices comprises a microelectromechanical system device.

31. The method of claim 26, wherein at least one of the first and second devices comprises an optical device.

32. An article comprising:
a first device; and
a second device bonded to the first device by a universal solder bond, wherein the universal solder bond is formed by disposing the first device comprising a contact pad within a vacuum chamber having a vacuum pressure, placing a universal solder preform on the contact pad, arranging the second device comprising a surface to be bonded within the vacuum chamber such that the surface to be bonded is aligned with the universal solder preform, and pressing the second device onto the solder preform.

33. The article of claim 32, wherein at least one of the first and second devices comprises an electronic circuit device.

34. The article of claim 32, wherein at least one of the first and second devices comprises a microelectromechanical system.

35. The article of claim 34, wherein the microelectromechanical system comprises an optical microelectromechanical system device.

36. The article of claim 32, wherein the first device comprises an elastically pre-strained fiber grating and the second device comprises a material and structure exhibiting a negative coefficient of thermal expansion.

37. The article of claim 32, wherein at least one of the first and second devices comprises an optical fiber device.

38. The article of claim 37, wherein the optical fiber device comprises an optical fiber grating.

39. An article comprising:
a first device; and
a second device bonded to the first device by a universal solder bond, wherein the universal solder bond is formed by coating at least a portion of a heated metal brush with a molten universal solder, pressing a second device onto the layer of molten universal solder thereby forming a solder joint between the first device and the second device, wherein a time from the coating of the at least a portion of the first device to the formation of the solder joint is less than or equal to one minute.

40. The article of claim 39, wherein at least one of the first and second devices comprises a microelectromechanical system.

41. The article of claim 40, wherein the microelectromechanical system comprises an optical microelectromechanical system device.

42. The article of claim 39, wherein at least one of the first and second devices comprises an electronic circuit device.

43. The article of claim 39, wherein at least one of the first and second devices comprises an optical fiber device.

44. The article of claim 43, wherein the optical fiber device comprises an optical fiber grating.

45. The article of claim 39, wherein the first device comprises an elastically pre-strained fiber grating and the second device comprises a material and structure exhibiting a negative coefficient of thermal expansion.

46. An article comprising:
a first device; and
a second device bonded to the first device by a universal solder bond, wherein the universal solder bond is formed by:
providing the first device spaced apart from the second device, wherein a space between the first device and the second device forms a joint area,
placing a universal solder preform in the joint area, melting the universal solder preform, wherein an oxide skin is formed on a surface of the molten universal solder preform, and
pressing the second device toward the first device to collapse the molten universal solder and create a mechanical disturbance of the oxide skin thereby allowing fresh molten universal solder to form a solder joint between the first and second devices.

47. The article of claim 46, wherein at least one of the first and second devices comprises a microelectromechanical system.

48. The article of claim 47, wherein the microelectromechanical system comprises an optical microelectromechanical system device.

49. The article of claim 46, wherein at least one of the first and second devices comprises an electronic circuit device.

50. The article of claim 46, wherein at least one of the first and second devices comprises an optical fiber device.

51. The article of claim 50, wherein the optical fiber device comprises an optical fiber grating.

52. The article of claim 46, wherein the first device comprises an elastically pre-strained fiber grating and the second device comprises a material and structure exhibiting a negative coefficient of thermal expansion.

53. A method of brazing or bonding two or more articles comprising:
providing two or more articles comprising bonding surfaces;
disposing a solder body between the bonding surfaces;
wetting the bonding surfaces with the solder body under substantially oxygen-free conditions; and
bonding the bonding surfaces under substantially oxygen-free conditions.

54. The method of claim 53, wherein the solder body comprises a universal solder or braze.

55. The method of claim 54, wherein the universal solder comprises a simple alloyed universal solder.

56. The method of claim 53, wherein the solder body comprises a rare earth element buried within the solder body.

57. The method of claim 53, wherein the solder body comprises a universal solder core covered with a noble metal film.

58. The method of claim 53, wherein the solder body comprises a universal solder core and a regular solder jacket

59. The method of claim 53, wherein the solder body comprises a universal solder paste.

60. The method of claim 59, wherein the universal solder paste comprises solder particles in a paste matrix.

61. The method of claim 60, wherein the solder particles comprise universal solder particles coated with a noble metal.

62. The method of claim 53, wherein one or more of the bonding surfaces comprises a stable inorganic surface.

63. The method of claim 62, wherein the stable inorganic surface comprises a semiconductor.

64. The method of claim 62, wherein the stable inorganic surface comprises a material selected from the group consisting of oxide, nitride, selenide, silicon, GaAs, GaN, fluoride diamond or stable metal.
